(19) United States
(12) Patent Application Publication
(10) Pub. No.: US 2017/0268720 A1
(43) Pub. Date: Sep. 21, 2017

(54) Paint Tray With Brackets

(71) Applicant: Donald Rogers, Chiefland, FL (US)

(72) Inventor: Donald Rogers, Chiefland, FL (US)

(21) Appl. No.: 15/459,686

(22) Filed: Mar. 15, 2017

Related U.S. Application Data
(60) Provisional application No. 62/308,475, filed on Mar. 15, 2016.

(51) Int. Cl. F16M 13/02; B65D 1/34; B44D 3/12

(52) U.S. Cl. CPC F16M 13/025; B44D 3/126; B65D 1/34

(57) ABSTRACT

A paint tray with brackets is provided. The paint tray with brackets includes a base, a pair of lateral sidewalls and a pair of longitudinal sidewalls extending from the base defining interior volume. A pair of brackets are disposed on opposing first and second corners, both of which are formed by the intersection of one of the longitudinal sidewalls and one of the lateral sidewalls. Each of the first bracket and second bracket includes a pair of opposing tabs surrounding an open slot, such that the first bracket and second bracket each maintain a u-shape. The open slot is configured to releasably engage the upper edge of an open container such as a paint can in order to easily pour the contents of the paint tray into another container.

### CROSS REFERENCE TO RELATED APPLICATIONS

This application claims the benefit of U.S. Provisional Application No. 62/308,475 filed on Mar. 15, 2016. The above identified patent application is herein incorporated by reference in its entirety to provide continuity of disclosure.

### FIELD OF THE INVENTION

The present invention relates to paint trays. More specifically, the present invention provides a paint tray with brackets for facilitating emptying of the paint tray contents into another container.

### BACKGROUND OF THE INVENTION

Paint trays are often used to hold paint so that is accessible to a working painter. Once the individual is finished painting, there is often a significant amount of paint left in the paint tray. It is desirable to pour the excess paint back into a paint can in order to minimize waste. However, it can be time consuming and difficult to pour paint from a typical paint tray into a paint can. Paint is often spilled during the process, which wastes paint and creates a mess that can be difficult to clean. Some individuals will attempt to balance an edge of the paint tray on the paint can while pouring to increase the stability of the paint tray. However, the paint tray can easily slip from the edge of the container, creating additional waste and a mess to be cleaned. In order to address these concerns, the present invention provides a paint tray with brackets that releasable engage the upper edge of a container in order to facilitate emptying the contents of the paint tray into the container without spilling.

### SUMMARY OF THE INVENTION

In view of the foregoing disadvantages inherent in the known types of paint trays now present in the prior art, the present invention provides a paint tray with brackets wherein the same can be utilized for providing convenience for the user when emptying the contents of the paint tray into another container. The present paint tray includes a base, a pair of lateral sidewalls, and a pair of longitudinal sidewalls extending from the base defining an interior volume. A first bracket is disposed on a first corner, the first corner formed by the intersection of one of the longitudinal sidewalls and one of the lateral sidewalls. A second bracket is disposed on a second corner distinct from the first corner, the second corner formed by the intersection of one of the longitudinal sidewalls and one of the lateral sidewalls. Each of the first bracket and second bracket comprises a pair of opposing tabs surrounding an open slot, such that the first bracket and second bracket each maintain a u-shape. The open slot is configured to releasably engage the upper edge of an open container.

One object of the present invention is to provide a paint tray that has all of the advantages of paint trays in the known art and none of the disadvantages.

Another object of the present invention is to provide a paint tray with brackets for facilitating pouring the contents of the paint tray into another container, such as a paint can or bucket.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the paint tray with brackets.

FIG. 2 shows a side view of the paint tray with brackets.

FIG. 3 shows a perspective view of the paint tray with brackets in use.

### DETAILED DESCRIPTION OF THE INVENTION

Reference is made herein to the attached drawings. Like reference numerals are used throughout the drawings to depict like or similar elements of the paint tray with brackets. For the purposes of presenting a brief and clear description of the present invention, the preferred embodiment will be discussed as used for easily emptying paint and other liquids into a container, such as a bucket or paint can. The figures are intended for representative purposes only and should not be considered to be limiting in any respect.

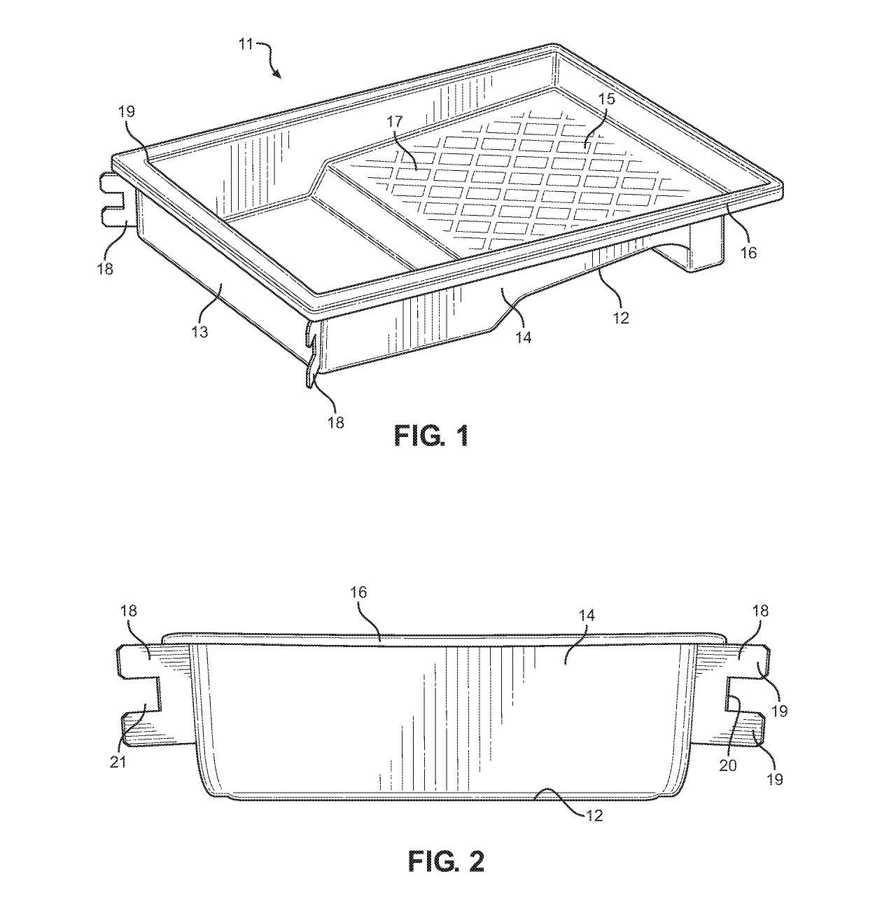

Referring now to FIG. 1, there is shown a perspective view of the paint tray with brackets. The paint tray 11 generally comprises a base 12 having a pair of opposing longitudinal sidewalls 14 and a pair of opposing lateral sidewalls 13, defining an interior volume 15. The interior volume 15 is utilized to store paint as it is being used by an individual. In the illustrated embodiment, the base 12 comprises a sloped upper surface having ridges 17 thereon, which facilitate movement of paint and prevents the paint from drying or sticking.

The paint tray 11 further comprises a continuous flange 16 disposed around an upper perimeter edge thereof. Additionally, a pair of brackets 18 are disposed on opposing corners 19 of the paint tray 11. Each corner 19 is formed by the intersection of one of the longitudinal sides 14 and one of the lateral sides 13. Each bracket 18 is oriented such that it aligns in the same plane as the angle bisector of the corner 19, which is a forty five degree angle. In the illustrated embodiment, two brackets 18 are shown. However, more or less brackets 18 may be utilized. For example, the paint tray 11 may include one bracket 18 on each corner, or may include one bracket 18 on one corner.

Referring now to FIG. 2, there is shown a side view of the paint tray with brackets. Each bracket 18 includes a pair of opposing tabs 19. The opposing tabs 19 are disposed on either side of an open slot 21 which includes an inner edge 20. The opposing tabs 19 and open slot 21 form a U-shaped bracket 18. In the illustrated embodiment, the brackets 18 are disposed on an upper end of the sidewall 14, such that they contact the continuous flange 16. In alternate embodiments, the brackets 18 may be positioned such that their lower edge is flush with the base 12 of the paint tray 11. Additionally, in the illustrated embodiment, the brackets 18 are dimensioned such that the width of each tab 19 is equal to the width of each open slot 21.

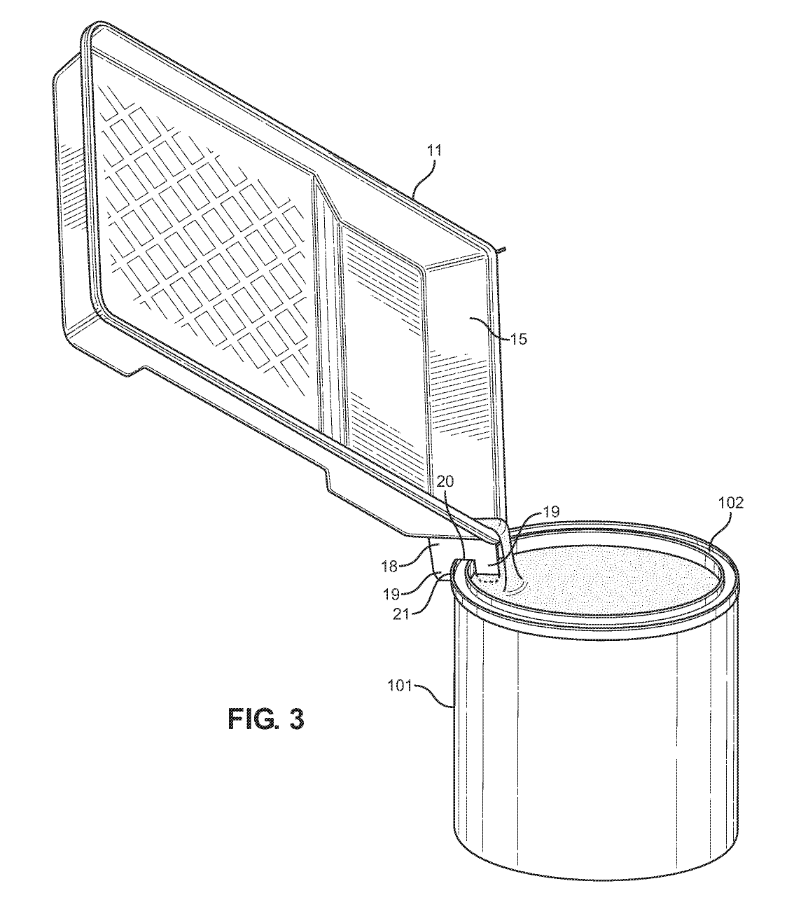

Referring now to FIG. 3, there is shown a perspective view of the paint tray with brackets in use. The paint tray 11 is shown having paint stored within its interior volume 15. The paint is being transferred from the paint tray 11 to a paint can 101 for storage. In use, a user may upend the paint tray 11 so that contents may be poured therefrom. The bracket 18 releasably engages the upper edge 102 of the paint can 101, such that the opposing tabs 19 contact inner and outer sides of the paint can 101. The upper edge 102 of the paint can 101 occupies the open slot 21 of the bracket 18, such that the upper edge 102 contacts the inner edge 20 of the open slot 21. In this way, the bracket 18 releasably engages the upper edge 102 of the paint can 101, such that paint stored within the paint tray 11 can be easily emptied into the paint can 101 while reducing the risk of spillage.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A paint tray, comprising:
a base;
a pair of lateral sidewalls and a pair of longitudinal sidewalls extending from the base defining an interior volume;
A first bracket disposed on a first corner, the first corner formed by the intersection of one of the longitudinal sidewalls and one of the lateral sidewalls;
a second bracket disposed on a second corner distinct from the first corner, the second corner formed by the intersection of one of the longitudinal sidewalls and one of the lateral sidewalls;
wherein each of the first bracket and second bracket comprises a pair of opposing tabs surrounding an open slot, such that the first bracket and second bracket each maintain a u-shape;
wherein the open slot is configured to releasably engage the upper edge of an open container.

2) The paint tray of claim 1, further comprising a continuous flange disposed on an upper perimeter edge thereof.

3) The paint tray of claim 1, wherein the first bracket and the second bracket are oriented in the same plane as an angle bisector of each longitudinal sidewall and each lateral sidewall.

4) The paint tray of claim 1, wherein the base comprises a sloped upper surface.

5) The paint tray of claim 1, wherein the base comprises an upper surface having a plurality of ridges thereon.

6) The paint tray of claim 1, wherein a width of the open slot is equal to a width of each of the pair of opposing tabs.
